(19) United States
(12) Patent Application Publication
(10) Pub. No.: US 2016/0148179 A1
(43) Pub. Date: May 26, 2016

(54) APPARATUS AND METHOD FOR MONITORING TRANSACTIONS INVOLVING A CONSERVED RESOURCE

(71) Applicant: GRESHAM FINANCIAL SYSTEMS LTD, Southampton Hampshire (GB)

(72) Inventors: Nicholas James, Southhampton Hampshire (GB); Jason Turner, Southhampton Hampshire (GB); Neil Vernon, Southhampton Hampshire (GB)

(73) Assignee: Gresham Finacial Systems Ltd., Southhampton Hampshire (GB)

(21) Appl. No.: 14/901,990

(22) PCT Filed: Jul. 3, 2013
(86) PCT No.: PCT/GB2013/051760

§ 371 Date: Dec. 29, 2015

(51) Int. Cl. G06Q 20/10; G06Q 20/38

(52) U.S. Cl. CPC G06Q 20/1085; G06Q 20/382

(57) ABSTRACT

A computer-implemented method and apparatus are provided for monitoring transactions involving a conserved resource, for example to monitor operation of a network of cash dispensing machines. The method comprises receiving into a computer monitoring system a plurality of data feeds relating to the transactions to be monitored, each data feed comprising successive rows of data, each data row in a given data feed comprising multiple data elements in accordance with a predetermined pattern. The method further comprises performing, within the computer monitoring system, a grouping analysis, on the received data feeds. The grouping analysis determines at least one data element in a first data feed from said plurality of data feeds corresponding to provision of said conserved resource, and at least one data element in a second data feed from said plurality of data feeds corresponding to consumption of said conserved resource. The method further comprises reconciling the at least one data element corresponding to provision of said conserved resource against the at least one data element corresponding to consumption of said conserved resource in order to monitor said transactions.

### FIELD OF THE INVENTION

The present invention relates to an apparatus and method of monitoring transactions involving a conserved resource using a plurality of data feeds, for example to monitor operation of a network of cash dispensing machines.

### BACKGROUND OF THE INVENTION

Computer systems are used for monitoring transactions of a conserved resource. A conserved resource is a resource which is not created or destroyed in a set of one or more matched transactions, but rather is preserved across (before and after) the set of transactions, analogous to the left hand side of an equation matching the right hand side of an equation. The conserved resource may be physical or non-physical. Examples of a conserved resource may be the disk storage available to a computer system, or money which is provided to and removed from a cash dispensing machine, also known as an automated teller machine (ATM).

In performing this monitoring, a computer system typically receives multiple different data feeds relating to the transactions. For example, in the case of ATM machines, the computer monitoring system may receive a real-time or near real-time first data feed directly from each ATM detailing every cash withdrawal from that ATM. The computer monitoring system may further receive a separate, second data feed, for example on a nightly basis, indicating the cash balance remaining in each of a first set of ATMs. A third data feed, likewise provided on a nightly basis, may include information about cash replenishments of a second set of ATMs performed that day. The first set of ATMs may be different from (but overlapping with) the second set of ATMs: as an example, the first set may comprise all ATMs located in a given type establishment, such as motorway service stations, and operated by a first party on behalf of a particular bank, while the second set of ATMs may comprise all ATMs in a given geographical district which are replenished by a second party on behalf of the bank.

It is important for a bank or other financial institution to be able to confirm that a given ATM is working correctly, such as dispensing the correct amount of money. It is also very important for the bank to be able to detect fraud or other illicit activity associated with the ATM. Accordingly, the information for a given ATM included in the first, second and third data feeds has to be extracted from the respective data feeds and subject to a reconciliation process. The reconciliation verifies that the conserved resource (money) has been correctly preserved across the set of transactions performed with respect to the given ATM—in other words, that the amount of cash inserted into the machine on a specified day less the amount of cash withdrawn from the machine on that day matches the change in balance from the night before the specified day to the night after the specified day.

Note that this verification of the operation of an ATM is often just part of a wider fabric of reconciliations that must be performed by a financial institution. For example, it must be confirmed that cash withdrawals from the ATM are matched by debits from the accounts of the relevant customers, likewise that replenishments to the ATM are also matched against debits from some appropriate operating account. Again, any problem with such reconciliations may indicate a machine failure—e.g. some form of hardware communications failure in the ATM, a software failure, such as some form of logic error in terms of how a transaction is implemented—or potentially some deliberate fraud, etc.

As another example, a computer server operates in the cloud to provide storage space to clients. The server receives updates relating to changes to the overall storage capacity of the system, such as the addition or removal of new disk storage devices, plus updates about the overall storage usage on each device. The server further receives updates for each user account about purchases of storage capacity, for storage allocated at a system level to that user account, and for changes to actual storage usage by that user account. The computer server can perform monitoring to confirm (for example) that the storage allocations are consistent with the purchased amounts of storage capacity, and that the aggregate storage usage by all the user accounts is consistent with the total storage usage across all devices. If this monitoring detects an inconsistency, this may indicate (for example), a hardware or software failure in one of the storage devices, or some misbehaving software that is managing to acquire storage outside that allocated to a given user account (accidentally or malevolently).

The number of transactions to be reconciled in a computer monitoring system is potentially very large. For example, a single ATM may be responsible for over a thousand transactions per day, while other types of system may involve tens of thousands of transactions or more. In addition, there is increasing pressure to perform the monitoring on a real-time or quasi-real-time basis in order to provide rapid detection of any unexpected or potentially erroneous behaviour. A further difficulty is that the monitoring may involve incoming data feeds from a number of different sources, and the format of the data presentation may vary from one data feed to another. Accordingly, the provision of computer systems for monitoring transactions involving a conserved resource in a complex environment represents a challenging task.

### SUMMARY OF THE INVENTION

The invention is defined in the appended claims.

### BRIEF DESCRIPTION OF DRAWINGS

Various embodiments of the invention will now be described in detail by way of example only with reference to the following drawings:

FIG. 1 is a schematic diagram showing a configuration of ATM machines with data feeds to a computer monitoring system in accordance with one embodiment of the invention.

FIG. 1A is a schematic diagram showing a configuration of ATM machines with data feeds to a computer monitoring system in accordance with another embodiment of the invention.

FIG. 2 is a schematic flowchart depicting an overview of the processing performed by a computer monitoring system in accordance with one embodiment of the invention.

FIG. 3 is a schematic diagram depicting an overview of the processing performed by a computer monitoring system in accordance with one embodiment of the invention.

FIG. 4 is a schematic flowchart illustrating in more detail the grouping analysis from operation 230 of FIG. 2 in accordance with one embodiment of the invention.

FIG. 5 illustrates a schematic flowchart representing the matching grouping analysis in accordance with one embodiment of the invention.

FIGS. 6-8 are screen shots illustrating various stages of the processing of FIG. 2 in accordance with some embodiments of the invention.

### DETAILED DESCRIPTION

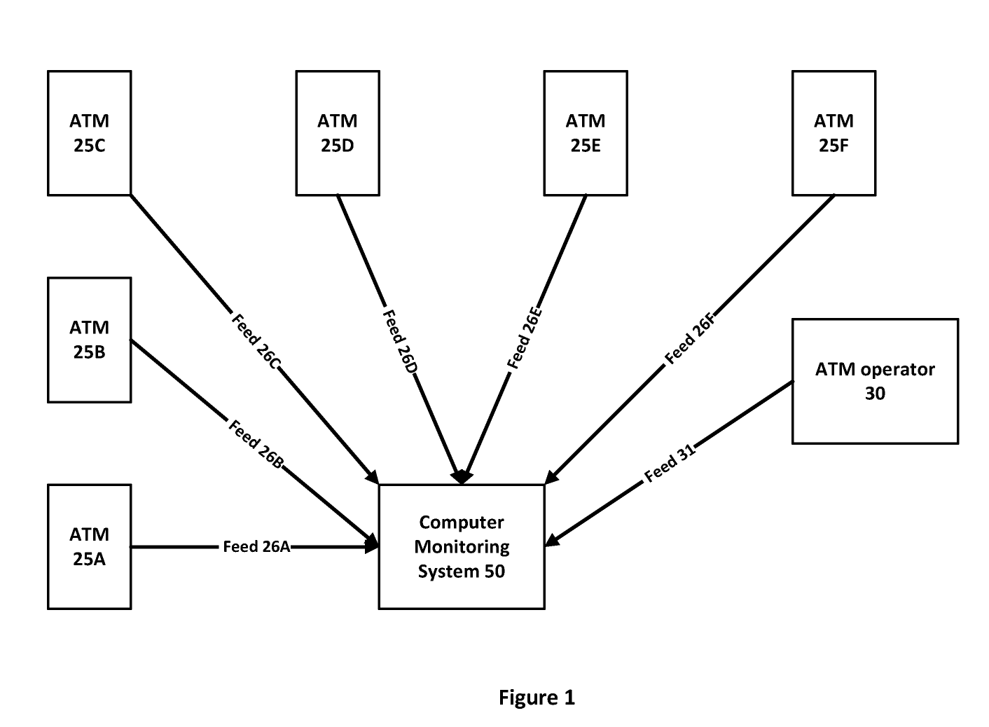

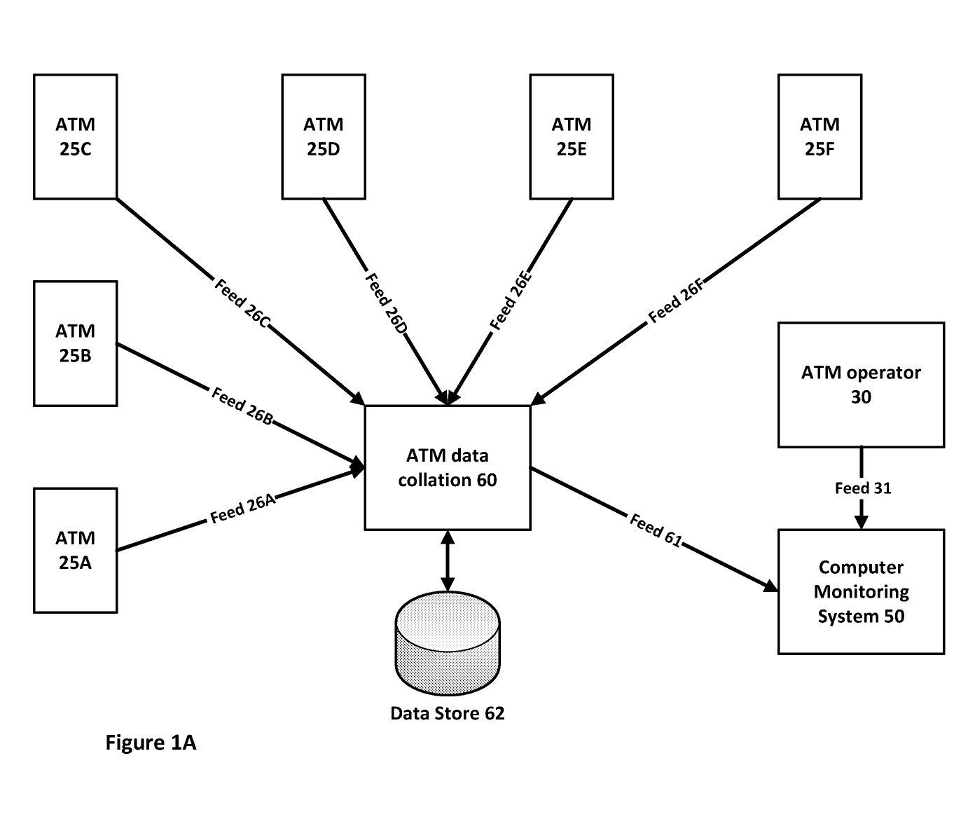

FIG. 1 is a schematic diagram showing a configuration of ATM machines with data feeds to a computer monitoring system in accordance with one embodiment of the invention. It will be appreciated that this diagram just represents one potential implementation of the approach described herein, and the same approach can be used in many other contexts, for example, with many other types of data feeds or streams from different machines, with different originating from different hardware systems and/or software programs, etc.

In FIG. 1, each of the ATM machines (automated teller machines) 25A . . . 25F has a respective data feed 26A . . . 26F to a computer monitoring system 50. It will be appreciated that the number of ATM machines 25 shown in FIG. 1 is by way of example only, and may be much higher in practice. FIG. 1 also illustrates an ATM operator system 30 which provides a corresponding feed 31 to the computer monitoring system 50. The data feeds 26 direct from the individual ATMs to the computer monitoring system 50 provide real-time information about each individual transaction (cash withdrawal) from that ATM. The data feed 31 from the ATM operator system 30 may be supplied on a daily (nightly) basis, and specifies the amount of money (cash) entered into each ATM 25. Note that there may be more than one ATM operator for the overall set of ATMs 25A-F, in other words, some ATMs 25 may be maintained by a first ATM operator, while other ATMs 25 may be maintained by a second (or third, etc) ATM operator. Consequently, the computer monitoring system 50 may receive data feeds 31 from multiple different ATM operator systems 30 (not shown in FIG. 1).

The data feeds 26, 31 may be provided over any suitable wired and/or wireless communications network, such as the Internet, a private intranet, the mobile telephone network, and so on. In addition, different data feeds may be provided over different networks, depending upon the particular circumstances and connectivity of any given ATM 25. The computer monitoring system 50 and the ATM operator system 30 may be implemented by a conventional computer system running suitable software and provided with suitable network connectivity.

FIG. 1A illustrates an alternative embodiment of the invention in which the various data feeds 26A . . . F from the respective ATMs 25A . . . 25F are fed first to an ATM data collation system 60, which can store the information in an associated data store 62. The ATM data collation system 60 is then responsible for aggregating the stored data from the data feeds 26A . . . F from all of the ATMs 25A . . . 25F for a predetermined time period, before passing the aggregated data over a data feed 61 to the computer monitoring system 50, for example, on a daily or nightly basis. This relieves the computer monitoring system 50 from the overhead of communicating on a very frequent basis with all the different ATMs 25. Note that some implementations may involve a hybrid or mixture of the embodiments of FIGS. 1 and 1A, in which some ATMs are directly connected to the computer monitoring system 50 (as for FIG. 1), while other ATMs are indirectly connected to the computer monitoring system 50 via an ATM data collation system 60 (as for FIG. 1A). Another possibility is that the ATM data collation system 60 receives and stores the incoming data feeds 26 while maintaining their individual identity, so that they can be separately forwarded as desired to the computer monitoring system 50 (rather than all aggregated into a single data feed 61).

The ATMs 25 of FIGS. 1 and 1A can be regarded as a form of product dispenser (where the product comprises bank notes), and the computer monitoring system 50 receives (i) information supplied from the machines themselves (via data feeds 26) indicating the amount of product each machine has dispensed, and also (ii) information supplied from the machine operator (via data feed 31) about the amount of product inserted into each machine. At least part of the role of the computer monitoring system 50 is to confirm or reconcile these two streams of information, to ensure correct operation of the ATMs in terms of dispensing the appropriate amount of product (and also correct reporting of this level of dispensing to the computer monitoring system).

Each data feed 26, 31, 61 received by the computer monitoring system 50 comprises multiple rows of data, where each row of data comprises a specified data structure, i.e. a number of fields of various types (date, integer, string, currency amount, etc). In some implementations, different rows in a given data feed may have different data structure. In such cases, a data value in each row might be used to indicate the data structure for that row, or there might be a fixed pattern, for example, every tenth row might have a different data structure from the other rows in the data feed. For simplicity however, we will assume that all the rows of a given data feed have the same specified data structure (but that different data feeds will generally have different data structures). In this case, we can regard a single data feed as corresponding to a two-dimensional array of data, having a set number of columns, each column corresponding to a particular data field in each row of data. The number of rows in the data feed is, in effect, unlimited, as long as the data feed continues to supply data. We also assume that the data stream is formatted or structured to allow the receiving computer system (such as computer monitoring system 50) to break the data stream into rows, and into the data fields within rows. This can be readily achieved, for example, by providing a data feed using a CSV structure (comma-separated variable) or using XML (extensible markup language) encoding.

Although it is assumed that the computer monitoring system 50 is able to parse each data feed sufficiently to identify the data fields and associated numerical/character values within each data field, in many cases the computer monitoring system 50 does not receive (or cannot interpret or directly utilise) information about the specific application/business context of the different data fields (columns) within the data feeds. Consequently, although the computer monitoring system 50 is tasked with performing a reconciliation on incoming data fields, the computer monitoring system 50 does not have specific information on how such a reconciliation is to be performed—namely which data fields in which data feeds are to be combined together or compared within one another for the purposes of the reconciliation. In accordance with an embodiment of the present invention, the computer monitoring system 50 therefore performs a form of bootstrap process, in which it searches through the raw data of the data feeds to identify potentially matching data, and then uses these identifications to perform a subsequent reconciliation process.

In some cases, the computer monitoring system 50 may be able to identify, or ask a user to identify, a particular type or class of reconciliation to be performed. For example, one class of reconciliation might be related to data feeds from a network of ATMs, such as shown in FIG. 1, while another class of reconciliation might represent checking packet flows within a communications network, or monitoring share purchases and settlements within an automated trading system, etc. For each class of reconciliation, certain “macro” behaviours may be identified to develop a template for that class of reconciliation—e.g. as to the likely information in the data feeds, the types of matching (grouping) to be performed, etc. Identifying such a template (if available) as a precursor for performing a reconciliation may allow the reconciliation to be determined more quickly and/or more accurately than would otherwise be the case.

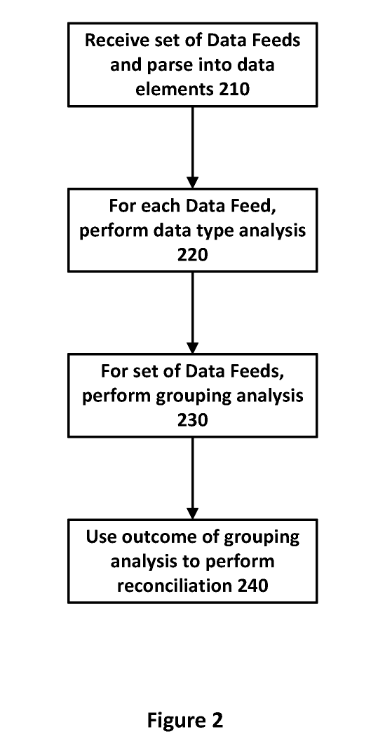

FIG. 2 is a schematic flowchart depicting an overview of the processing performed by computer monitoring system 50. The processing commences with receiving a set of data feeds as discussed above and parsing into data elements (operation 210), i.e. identifying the data rows and the individual data fields (and their values) within each row. This operation may typically include a user specifying data files for the system, where each data file corresponds to a different data feed arranged into a suitable structure or format. In other embodiments, the system may be configured (for example) to receive the data feeds directly into an appropriate storage facility, with the reconciliation then being performed after at a certain time, or after a certain amount of data has been received.

As noted above, different data feeds may have different data structures, and hence have to be parsed in a different manner according to their respective data structure. It is assumed that the received data is representative of the data supplied by the relevant data feeds. The amount of data received for this processing may be very large, for example, the received data may be aggregated for a complete day and may comprise many millions of data lines (rows). In view of the scale of data to be processed, internal data representations for the analyses shown in FIG. 2 are extremely efficient, as described in more detail below, and the processing routines are highly performant. Each data feed is processed to perform a data type analysis (operation 220), which tries to identify the nature of the various columns in a data feed, using both intrinsic and extrinsic indications (if available). The intrinsic indications are based on the actual data values within the data feed, which can be classified, inter alia, based on the nature of the data value itself. Thus, if the data values in one column comprise a mixture of numerical and character values, such as “ABC 123”, this will generally represent some form of label, rather than a numerical value for a conserved resource which is directly involved in a reconciliation. Conversely, data values which are are specified with two digits and a decimal point, such as 150.00 might well represent an amount of money (currency), and hence are much more likely to represent a numerical value for a conserved resource which is directly involved in a reconciliation. Thus in the context of the system shown in FIGS. 1 and 1A, a label such as ABC123 might be used to identify a given ATM 25, while a numerical amount such as 150.00 might represent the amount of withdrawn cash from the ATM. Another example of an intrinsic indication is that a number or string with a data feed which is or contains “2013” might well represent a date, and the corresponding column can be utilised accordingly. More particularly, if most or all data values in a given column contain “2013” then this column is highly likely to represent a date (whereas if an isolated data value in a column contains 2013, but most of the other data values in that column do not, then the column is less likely to represent a date).

An extrinsic indicator might be provided, for example, by a column header in a data field, which might specify “date”, “credit”, “balance” or some such descriptive term. An extrinsic indicator might also be provided for an XML data feed, since such a data feed will be encoded in accordance with a data schema, which specifies the structure and expected elements of the data feed. In some cases however, such external indicators may not be available, or alternatively the computer monitoring system 50 might not be able to (fully) understand or utilise the external indicators that are supplied for a data feed.

The outcome of the data type analysis is that those columns (if any) for which the analysis has been at least partly successful, are provided with tags to indicate the information held by the respective columns. In particular, the computer monitoring system 50 has a set of tags or labels that are applied to all columns of all data feeds (to the extent that the data type analysis is successful). This then leads to a labelling that is homogeneous across all the data feeds, in that the same tags are used to denote the same data types across different data feeds. In contrast, any extrinsic data received at operation 210 from the various data feeds is likely to be heterogeneous, and hence cannot be compared or utilised directly across the set of data feeds.

In some embodiments, the output of the data type analysis is presented to a user for confirmation and/or correction as appropriate (to the extent that the user is able to makes such confirmations/corrections)—as described below in more detail. In other embodiments, the computer monitoring system 50 may utilise the output of the data type analysis directly, without user intervention.

The processing of FIG. 2 now performs a group analysis across the set of data feeds (operation 230), which is an iterative process for discovering relationships between the various data feeds. In particular, the grouping analysis identifies ways of grouping data from the data feeds in order to find agreement (reconciliation/relationships) between the groups. These relationships may be complex and involve many attributes (data fields), so that the search space of possible relationships can be very large. One way of facilitating the grouping analysis is to randomly sample the received data to perform the grouping analysis. Another way of facilitating the grouping analysis is to use the information from the data type analysis to make sensible predictions about possible groupings. For example, if the conserved resource of interest is money, then this is often represented by an amount which is recorded in a certain format (such as two digits after a decimal point).

The grouping analysis considers many possible groupings, and the correspondence between them is classified and the statistical significance determined to examine how well the possible grouping fits the entire data set. This approach is able to find significant matching relationships between feeds in which there is only a small proportion of matches over large feeds with high degrees of complexity. In some embodiments, the computer monitoring system includes an engine for configuring matching that is not based on matching amounts, but only on verifying a relationship between known business data types. This kind of matching is referred to as “reference data reconciliation” and is performed by grouping data in the feeds (usually by a common identifier on both sides) to identify the most common ways of matching. The system can then pick out exceptions to the norm, which may potentially indicate locations where a data set is in error.

The grouping analysis is also able to identify relationships between the feeds which are based on an analysis of data within column values. For example, if a business attribute in one feed has sub-string references to identifiers in another feed, these can be used to establish a new relationship between the feeds. The grouping analysis may also use external files to look up values for use in the analysis.

After the grouping analysis has been performed, the computer monitoring system suggests matching configurations, and provides statistics about each suggestion. This is an iterative process: once a matching configuration is chosen, the analysis can be run on the remaining data sets. This iterative process is then translated into a multi-stage matching configuration, which can in turn be used for performing future data reconciliations (operation 240).

In some application domains, the amounts must be used for grouping, because the relationship between identifiers in the data feeds is unknown. In these cases, the grouping analysis examines groups within each feed to generate aggregate amounts, and then finds correspondences between the feeds based on these aggregate amounts. The approach adopted is to identify aggregates that agree in aggregate, and then to generate virtual columns based on these aggregates to feed into the grouping analysis. Results based on this procedure are reflected in the matching configuration.

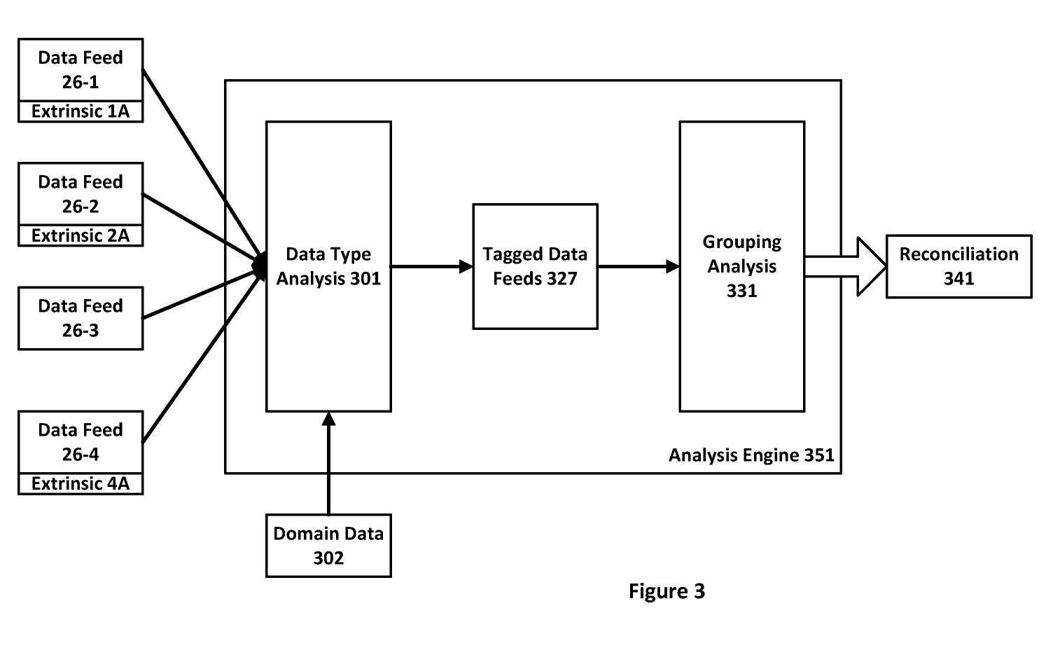

FIG. 3 is a schematic diagram depicting an overview of the processing as described above, as performed by a computer monitoring system in accordance with an embodiment of the invention. The computer monitoring system includes an analysis engine 351 which receives multiple data feeds, 26-1, 26-2, etc. The number and format of these data feeds will vary from one implementation to another. In addition, in some cases the data feeds may be aggregated into a single input to the analysis engine (assuming that the data rows from different data feeds are suitably labelled or otherwise identifiable).

Each data feed 26 may or may not be accompanied by extrinsic data 1A, 2A, 3A, in other words, information supplementary to that provided by the sequence of data rows in the data feeds. The extrinsic data may, for example, comprise column header information, and/or XML tag or structure data. The extrinsic data helps the analysis engine to understand the contents of a respective data feed, for example, that a particular column of the data might represent a date. In any given implementation, none, some or all of the data feeds may be supplemented by extrinsic information.

In some implementations, the analysis engine may also receive domain data 302 that provides information which may be helpful to the data type analysis and/or the grouping analysis. This domain data might comprise, for example, currency exchange rates on different dates, and so on, or an alias file that provides known mappings in terminology between the labelling of different data feeds. Note that in some implementations, the extrinsic information, for example, XML structure data, may be provided as domain data 302 (instead of or as well as accompanying the individual data feeds 26-1, 26-2, etc).

As described above, the data from the various data feeds is passed into the analysis engine 351, which performs a data type analysis 301 using the received data feeds 26, including any available extrinsic data 1A, 2A, and also using any available domain data 302. The data type analysis 301 outputs a set of tagged data fields 327 to the grouping analysis 331.

The data type analysis may incorporate two types of enrichment. The first type is to tag the data columns based on any extrinsic information, domain data 302, and/or recognition of values within individual data columns (such as dates, labels, etc). In some embodiments, the tagging may be presented to a user for confirmation before output to the grouping analysis. A second type of enrichment is to supplement the data feeds with additional columns, referred to as virtual columns.

The tagging is determined from the intrinsic data (raw data values), plus any available extrinsic and/or domain data. At a minimum the tagging indicates, for example, data type, such as string, number to two decimal places, etc. In other situations, the tagging may be considerably more sophisticated, depending on the available extrinsic information. For example, the tagging might use the extrinsic information to identify a particular column of a data feed as corresponding to the amount of a cash withdrawal from an ATM—data that is clearly then of significance in monitoring the correct operation of the system.

There are various possibilities for the virtual columns. In some cases, a virtual column may comprise an additional label, determined from a mapping provided in an alias file as part of the domain data 302. Thus a given data feed might include a first label (say as an identifier for a given ATM) which is mapped using the alias file into a second (alternative) label which is incorporated into the data feed as an additional column. This second label may be more useful for matching against other data feeds (which may use the second label in preference to the first label).

Another type of data enrichment is to create virtual columns which are mathematical combinations or scaling or original columns. For example, a given data feed from an ATM might specify the number of notes of each denomination that have been withdrawn. A virtual column could then be created to reflect the total amount of the withdrawal, such as by summing, across all denominations, the number of notes for the denomination multiplied by the value for that denomination. These virtual columns will generally be specified by the user, based on tagging information where available.

The tagged data feeds 327 (including any virtual columns) are then subject to grouping analysis, which investigates relationships between the various data columns in different data feeds (as described below in more detail). The grouping analysis 331 is an iterative process, generally subject to confirmation by a human operator. In other words, the grouping analysis may determine a suspected relationship, which is then presented to a human operator to confirm or deny. Such a relationship generally links the provision of a conserved resource to the consumption of the conserved resource. For example, in the context of ATM machines, the provision of the conserved resource corresponds to filling an ATM machine with cash, while consumption of the conserved resource corresponds to making a withdrawal of cash from the ATM machine.

Once the grouping analysis 331 has been completed, the analysis engine (or some other component) is now able to perform a reconciliation 341 of the various data feeds based on the relationship(s) identified by the grouping analysis. This reconciliation 341 is looking to confirm correct operation of the transaction system being monitored (or conversely, looking to detect any incorrect or subversive operation). Note that once the relevant relationships have been identified by the grouping analysis, then the reconciliation can be performed on an ongoing basis using the results of this grouping analysis 331. In other words, the grouping analysis only needs to be performed as part of an initial set-up phase, and does not need to be repeated unless the structure of the data feeds changes (or possibly to search for any additional relationships not discovered by the initial phase of grouping analysis).

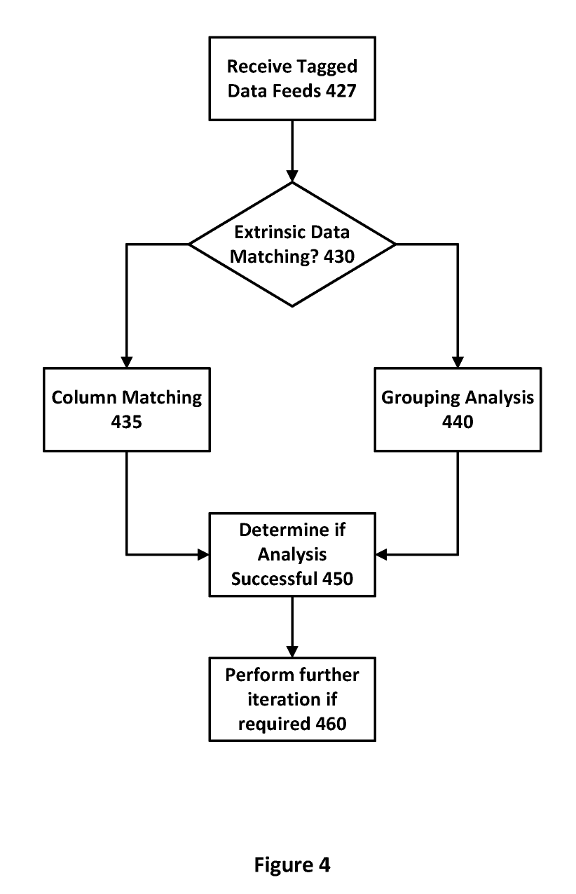

FIG. 4 is a schematic flowchart illustrating in more detail the grouping analysis from operation 230 of FIG. 2 in accordance with some embodiments of the invention. The processing of FIG. 4 commences with receipt of the tagged data (operation 427). The analysis engine 351 determines whether the tagged data includes enough extrinsic information to try and perform the matching (operation 430). If so, the analysis engine attempts to perform the matching based on this extrinsic information (operation 435), otherwise a grouping analysis is performed (operation 440). It is now determined whether the matching (whether based on tagged information or by a grouping analysis) has been successful (operation 450). A further iteration may then be performed (operation 460)—this decision may be performed manually, subject to user input, or automatically, based on the proportion of data values covered or explained by the matching or grouping analysis. Note that any new iteration incorporates knowledge of the previous iteration(s), so that the new iteration does not repeat groupings which have already been previously rejected by the user. In addition, the grouping analysis does not try to perform reconciliations on portions (rows) of the data feeds that have already been reconciled or explained by a previous iteration.

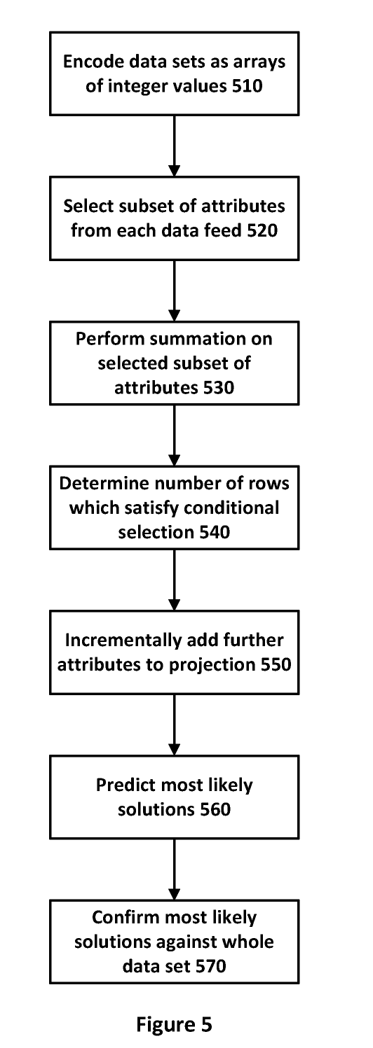

FIG. 5 illustrates a schematic flowchart representing the matching grouping analysis (operation 440) from FIG. 4 in accordance with one embodiment of the invention. In formal terms, using the terminology of relational databases, we can consider each data feed 26-1, 26-2, etc as comprising multiple tuples (data rows) of a relation (table). Assuming that a first data feed 26-1 is denoted as Relation R, and a second data feed 26-2 is denoted as Relation S, the grouping analysis seeks to maximise the set of Tuples (rows of the data feeds) that satisfy Equation (1):

Max(σ_{A=B}(R×S)) (1)

In effect, Equation (1) seeks to maximise the number of Tuples that satisfy a conditional Selection on the Cartesian product of the two Relations (R and S). The conditional operation is an equality operation on the corresponding attributes (columns of the respective data feeds), derived from the Projection operations described below in Equations (2) and (3):

A=Φ_{a1, a2, . . . ai(a1, a2, . . . aiGsum(ak))}(R) (2)

B=Φ_{a′1, a′2, . . . a′i(a′1, a′2, . . . a′iGsum(a′k))}(R) (3)

The above equations describe the following general procedure illustrated in FIG. 5. Thus the optimisation of Equation (1) is a mathematical optimisation to maximise the number of rows consisting of a set of rows that satisfy a condition on a number of attributes from both sides for a given data set. The complete search space for such a problem, in many practical situations, exceeds the computational capabilities of current computer systems for an exhaustive search. Accordingly, the processing of FIG. 5 incorporates various strategies such as dynamic programming in order to render the optimisation tractable. Note that some or all of these various strategies may or may not be utilised in various implementations, depending on the particular scale and circumstances of any given implementation.

The processing of FIG. 5 commences with transforming or encoding the data sets from the tagged data feeds 327 (see FIG. 3) into arrays of integer values (operation 510). This encoding allows the data values to be projected and grouped by equality very efficiently—especially in view of the large number of sampling operations to be performed, as discussed below. (In other embodiments, the grouping might be done using the raw data values from the tagged data feeds, without such encoding, depending on the circumstances of a given implementation).

The grouping analysis now commences by investigating a small projection (in effect, a projection involving a small number of columns). The calculations expressed by Equations (2) and (3) are now performed with respect to the selected data set. Thus a set of attributes a1 to ai is selected from each file (operation 520). This selection make take into consideration the tagging (if any) of the various data columns. For example, if two columns in two respective data feeds have both been identified as dates, then these two columns might both be selected in order to perform comparable groupings. Note that for a small projection, the set of selected attributes is relatively small (compared with the overall number of attributes in the data set).

The selected attributes are then used as grouping criteria to perform a summation on an attribute ak which does not belong to this first set (operation 530)—in Equations (2) and (3), this is notated as a1, a2, . . . aiGsum(ak). The resulting projections A and B are inserted into Equation (1) to determine the number of rows which satisfy the conditional selection (operation 540) in order to maximise this number.

The procedure of FIG. 5 is therefore trying to identify the following unknown parameters:
initial grouping attributes
a summation attribute (also referred to as the “netting” attribute) for the reconciliation
a relation by which the attributes pair together from two different sides (data feeds) in a way which maximises the number of satisfied Tuples in Equation (1).

As noted above, the initial phase of this investigation considers only small projections and (random) samples of the projected attributes (ak) in order to limit the computational requirements. After the initial phase of the investigation to determine one or more (small) projections of interest (which produce relatively large numbers of satisfied Tuples as per Equation (1)), the analysis engine 351 considers the effects of incrementally adding further attributes to the projections (operation 550) and examines these expanded projections in the same manner as discussed above in relation to operations 520 through 540. The result is a series of projections with corresponding net value (reconciled) attributes, including statistics about how well they form groups based on the samples that were considered. This information allows a prediction to be made (operation 560) of which are the most likely solutions, and these most likely solutions are then tested against the whole data set (operation 570) in order to confirm (or reject) a predicted grouping.

As an example of the above processing, consider a first data feed for reporting the end-of-day cash balance at various ATMs. This data feed may include a number of columns including: cash balance, the change in cash balance since the previous date, a label for a given ATM, date, a number representing the total number of withdrawals performed from the machine, an identifier for the person who performed any replenishment and the numbers of notes of different denominations added to the machine, i.e. a column for the number of £5 notes, a column for the number of £10 notes, etc. A second data feed may report cash withdrawals from various ATMs and include columns providing a label for an ATM, a date of withdrawal, plus the amount of the withdrawal, as well as various other information identifying the person making the withdrawal (card number, etc). Note that these different attributes may or may not be tagged (or may only be partly tagged) in the first and second data feeds.

The grouping analysis may firstly find that by selecting on date and ATM label in each data set, and by summing all cash withdrawals from the second data feed, the total will match the change in cash balance in the first data feed for data rows with no identifier for the replenishment. This matching reflects a reconciliation (and confirms correct operation of the ATM machine) in the case of no replenishment. As a further match (or as an enhancement of the first match), it may be determined that by selecting on date and ATM label in each data set, and for data rows with an identifier for the replenishment, a reconciliation can be performed by summing all cash withdrawals from the second data feed, and this total will match the change in cash balance less the total replenishment amount. As a further match (which leads to a separate reconciliation, i.e. independent of cash balance in an ATM), it may be determined that by selecting on date and ATM label in each data set, the number of cash withdrawals in the first data set should equal the number of data rows for individual cash withdrawal transactions in the second data set.

The analysis engine 351 described herein is able to analyse large data sets, for example, it has been used on data sets of more than 10 million line items. A variety of techniques are employed in order to support and facilitate the analysis of such large data sets, including:
Files are loaded very quickly with separate threads used to read the files and to perform analysis. The analysis engine 351 uses fast (lock-free) techniques for loading and process synchronisation.
Detailed data type analysis in section 301 reduces unnecessary work in the discovery of a matching configuration. The detailed nature of the analysis of the data types from individual feeds 26 simplifies and expedites the work required to bring out the relationship(s) between feeds.
Compressed data representation reduces the memory requirements and makes for efficient projection and grouping. Each row (line of data feed) is represented as an array of integers, and each integer identifies a normalised value relative to the column type. This cuts down on data repetition and generally reduces the overheads of memory, for example in a Java Virtual Machine (JVM) host. These data structures, namely the arrays of integers, are also highly efficient for simple equijoins because only the integer reference numbers are compared, not the actual values.
Sampling is performed to discover netting columns, and the procedure that identifies possible ways of matching is separated out from the procedure that gets actual statistics on match rates. In other words, the possible ways of matching are firstly identified by testing appropriate random samples of the data. The actual match rates are then tested on the whole data set to determine the statistical success rate of the proposed matching. This two-phase approach accelerates the generation of possible solutions.
Multi-core processing is used to validate (get the statistics for) possible solutions. The process of checking possible solutions is highly efficient on large data sets because it can fully utilise multi-core architectures for testing the solutions, and scales directly with increasing processor resources.
“Inexact” associations between columns are processed efficiently. When looking at non-equijoin relationships between feeds, and considering the likelihood of matches that are not exact matches, the matching can be processed in parallel. This is again done in a way that scales with hardware resources, specifically in terms of CPU cores.

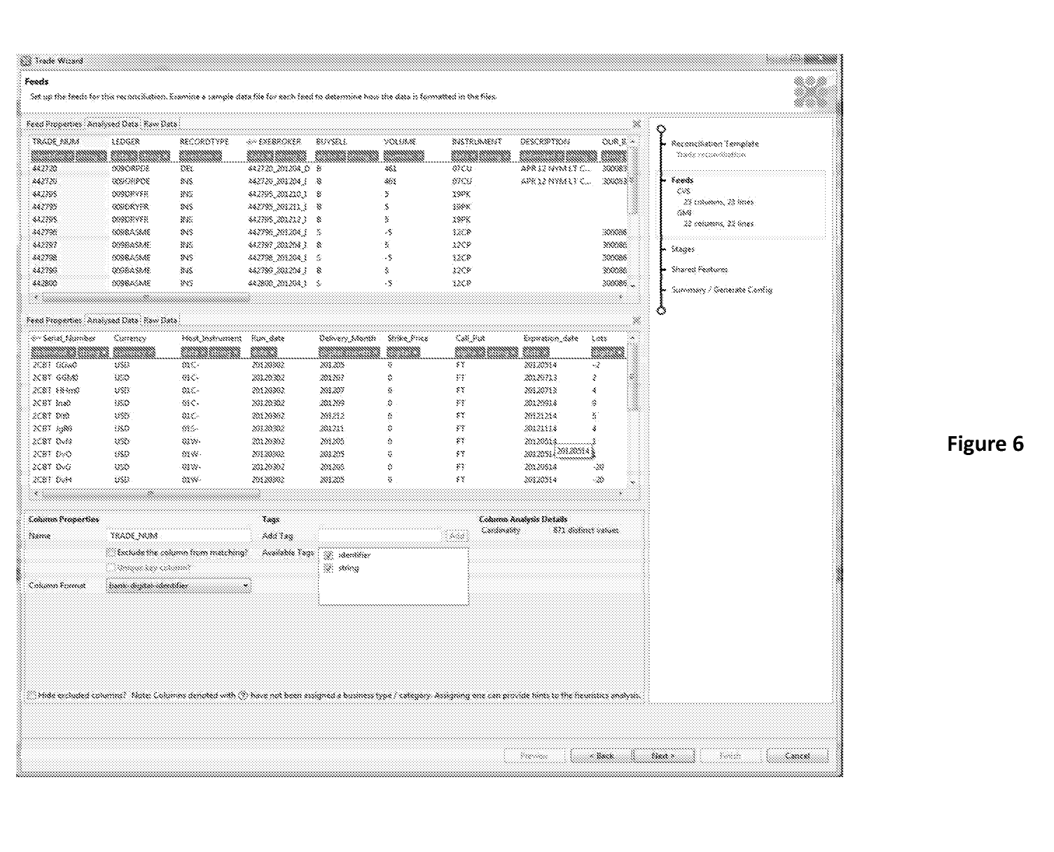

FIGS. 6-8 are screen shots illustrating various stages of the processing described above in accordance with some embodiments of the invention. FIG. 6 depicts a screen displayed as part of the data type analysis (operation 220 in FIG. 2). There are two panes displayed on the left/centre portion of the screen, each representing a corresponding data feed—the feed for the top pane is denoted CVS, while the feed for the bottom pane is denoted GMI—as indicated by a third pane arranged on the right of the screen. (This third pane also provides additional information, such as the current stage of the processing, and the number of columns in each of the two data feeds).

Within each data feed pane, the actual data from the data feed is provided as multiple lines (rows) of data arranged into columns. The columns have, as a result of the data type analysis (including the use of any extrinsic data for a given data feed 26 or domain data 302), been given a column title plus some indication of data type. In some cases the data type may represent a more primitive data type, such as string, number or date, while in other cases the data type may be more application-specific to the particular context, such as currency. Note that the data may be absent for certain rows and certain columns—see, for example, the DESCRIPTION column in the top pane, which is not populated for all data rows.

In FIG. 6 the user has selected the first column in the top pane, labelled TRADE_NUM (this is shown high-lighted). The section of the screen underneath the lower pane then provides further information about this column, such as the number of distinct values within the column, and also allows certain operations to be performed with respect to this column—e.g. changing the name or label of the column, and adding a tag. (Although the user is able to make such changes to the data analysis for each column, in practice this is often found to be unnecessary, given the output from the automated data type analysis of operation 220).

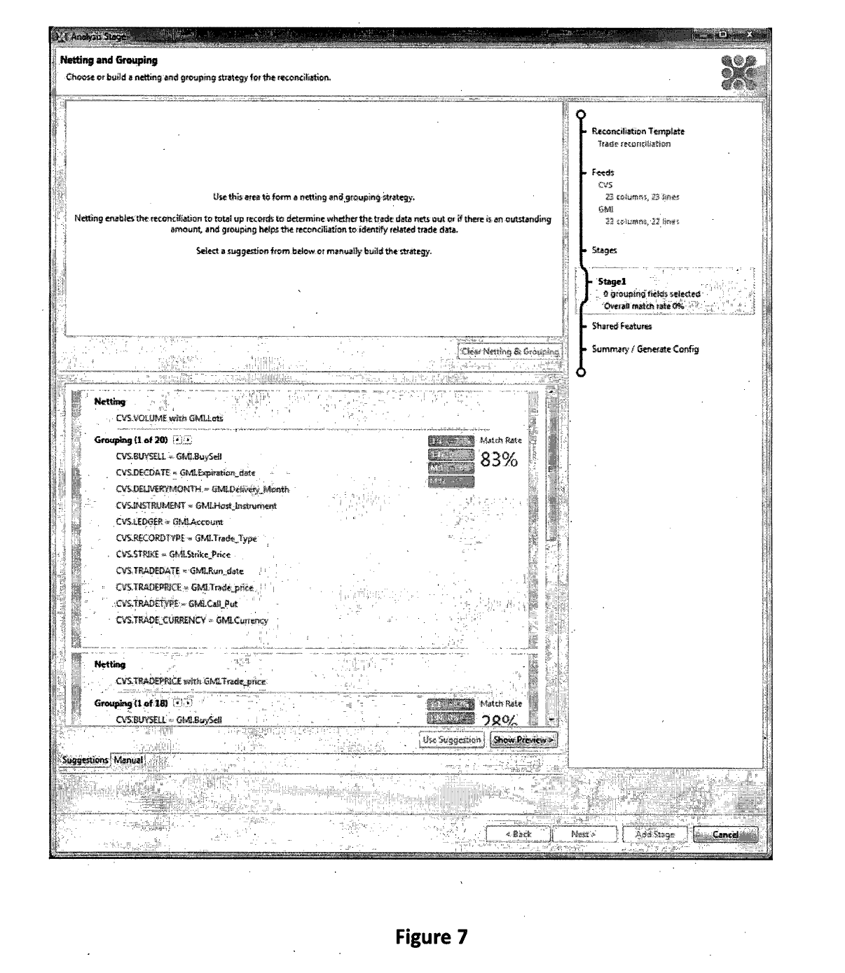

FIG. 7 is a screen-shot illustrating a first output from the analysis engine 351 in respect of the matching analysis (corresponding to operation 230 in FIG. 2). Potential matches are broken into different strategies or ways of grouping the data to make the best sense of it (each strategy is referred to as a stage). As shown in the lower pane of this screen, the analysis engine 351 is able to perform a netting (reconciliation) between the column VOLUME in the CVS data feed and the column Lots in the GMI data feed, based on a fairly extensive set of column groupings specified lower in the same pane. This netting has a match rate of 83%—in other words, the resulting netting is zero (i.e. matches) on 83% of the rows (lines of data in the data feeds 26). A portion of a second potential netting is shown in the lower part of the lower pane in FIG. 7. This second potential netting, based on the corresponding grouping, applies to 28% of the data rows.

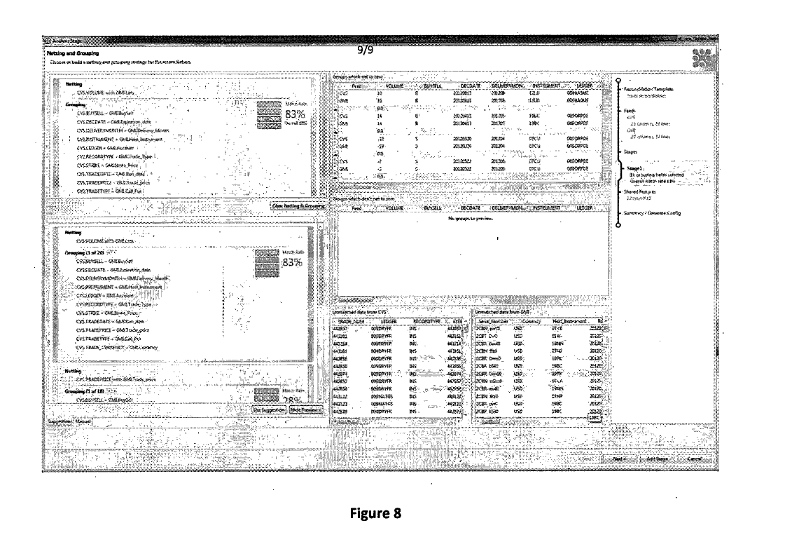

FIG. 8 is a screenshot showing what has been reconciled so far through the auto-discovery process and what remains to be reconciled, thereby providing the user with immediate visual feedback as to the extent to which the reconciliation rules so far identified are working. In particular, the screen-shot of FIG. 8 comprises a number of panes. The top left pane corresponds to the netting identified in FIG. 7, namely the column VOLUME from data feed CVS with the column Lots from the GMI data feed, and using the specified grouping. The top centre pane of FIG. 8 shows the pairing of rows in accordance with this grouping. In particular, each pair of rows comprises one row (top) from the data feed CVS and one row (bottom) from the data feed GMI. The first column in this pane identifies the data feed (CVS or GMI), while the headings for the remaining columns are taken from the column names or labels in (or assigned to) the CVS data feed. The second column in this pane is VOLUME, and presents the reconciliation identified in the top left pane. The remaining columns in this pane show how the data has been grouped, i.e. by matching field values in the CVS data feed with corresponding field values in the GMI data feed.

The central pane of FIG. 8 shows any pairs of rows from the CVS/GMI data feeds that match in terms of the grouping, i.e. that satisfy the grouping, but which do not net to zero, i.e. which do not reconcile properly with one another. It can be seen that this pane is empty—in other words, all the rows in the CVS/GMI data feeds that match the grouping criteria do net to zero.

The two lower central panes of FIG. 8 show the remaining lines of data from CVS (lower central, left) and GMI (lower central, right) that have not yet been matched—i.e. the system has not been able to find pairs of unmatched rows from these two data feeds (one from each) that satisfy the grouping criteria for this netting operation. The button lower right Add Stage then allows a further stage (reconciliation/grouping) to be performed (corresponding to operation 460 in FIG. 4), and this iteration process continues until all the data rows in the two data feeds have been successfully reconciled, or no further row pairs can be matched (or the user terminates the search).

The above embodiments rely on various processing, such as analysing the received data feeds to perform the grouping analysis, which may be performed by specialised hardware, by general purpose hardware running appropriate computer code, or by some combination of the two. For example, the general purpose hardware may comprise a personal computer, a computer workstation, a distributed network of (potentially heterogeneous) computer machines etc. The computer code may comprise computer program instructions that are executed by one or more processors to perform the desired operations. The one or more processors may be located in or integrated into special purpose apparatus. The one or more processors may comprise digital signal processors, graphics processing units, central processing units, or any other suitable device. The computer program code is generally stored in a non-transitory medium such as an optical disk, flash memory (ROM), or hard drive, and then loaded into random access memory (RAM) prior to access by the one or more processors for execution.

In conclusion, the skilled person will be aware of various modifications that can be made to the above embodiments to reflect the particular circumstances of any given implementation. For example, although the embodiments described above have primarily been explained in the context of monitoring the correct operation of a network of cashpoint machines, an analogous approach can be used in many other contexts where a reconciliation is to be performed across large, complex data sets. Moreover, the skilled person will be aware that features from different embodiments described above can be combined as appropriate in any given implementation. Accordingly, the scope of the present invention is defined by the appended claims and their equivalents.

What is claimed is:

1. A computer-implemented method of monitoring transactions involving a conserved resource, said method comprising:
receiving into a computer monitoring system a plurality of data feeds relating to the transactions to be monitored, each data feed comprising successive rows of data, each data row in a given data feed comprising multiple data elements in accordance with a predetermined pattern;
performing, within the computer monitoring system, a grouping analysis on the received data feeds, wherein said grouping analysis determines at least one data element in a first data feed from said plurality of data feeds corresponding to provision of said conserved resource, and at least one data element in a second data feed from said plurality of data feeds corresponding to consumption of said conserved resource; and
reconciling the at least one data element corresponding to provision of said conserved resource against the at least one data element corresponding to consumption of said conserved resource in order to monitor said transactions.

2. The method of claim 1, wherein the grouping analysis identifies one or more stages of reconciliation, wherein each stage of reconciliation includes: (i) one or more grouping attributes, (b) a summation or netting attribute.

3. The method of claim 2, wherein said grouping analysis seeks to maximise the number of Tuples (rows of the data feeds) that satisfy Max(σ_{A=B}(R×S)), wherein R and S are Relations corresponding to respective data feeds, and A and B are projections of the respective data fields, thereby maximising the number of Tuples that satisfy a conditional Selection on the Cartesian product of the two Relations R and S.

4. The method of claim 3, wherein the projection A from R is defined as Φ_{a1, a2, . . . ai(a1, a2, . . . aiGsum(ak))}(R), and is performed by selecting a set of grouping attributes a1 to ai from R to use as grouping criteria to perform a summation on a summation attribute ak which does not belong to this first set, this being notated as a1, a2, . . . aiGsum(ak), and likewise for projection B from Relation S.

5. The method of claim 2, further comprising performing multiple stages of reconciliation.

6. The method of claim 1, wherein the grouping analysis comprises:
selecting a sample of the data rows from the data feeds for performing the grouping analysis to identify data elements for a potential reconciliation; and
confirming a potential reconciliation by applying the reconciliation to all the data rows from the data feeds.

7. The method of claim 1, further comprising performing a data type analysis on the data feeds prior to the grouping analysis.

8. The method of claim 7, wherein the data type analysis utilises only intrinsic data from the data feeds.

9. The method of claim 7, wherein the data type analysis utilises extrinsic data relating to the data feeds.

10. The method of claim 9, wherein the extrinsic data comprises domain data.

11. The method of claim 7, wherein the data type analysis includes performing data enrichment on at least one of the data feeds.

12. The method of claim 11, wherein the data enrichment includes supplementing at least one data feed with a virtual column.

13. The method of claim 1, further comprising representing each row of a data feed as an array of integers.

14. The method of claim 13, wherein each integer identifies a normalized value relative to a column type for the data feed.

15. The method of claim 13, wherein equijoins are performed by comparing integer reference numbers.

16. The method of claim 1, wherein at least one of said data feeds includes data on cash withdrawals from automated teller machines (ATMs).

17. A non-transitory computer-readable storage medium storing instructions that when executed by a computer cause the computer to perform a method for monitoring transactions involving a conserved resource, said method comprising:
receiving into a computer monitoring system a plurality of data foods relating to the transactions to be monitored, each data feed comprising successive rows of data, each data row in a given data feed comprising multiple data elements in accordance with a predetermined pattern;
performing, within the computer monitoring system, a grouping analysis on the received data feeds, wherein said grouping analysis determines at least one data element in a first data feed from said plurality of data feeds corresponding to provision of said conserved resource, and at least one data element in a second data feed from said plurality of data feeds corresponding to consumption of said conserved resource; and
reconciling the at least one data element corresponding to provision of said conserved resource against the at least one data element corresponding to consumption of said conserved resource in order to monitor said transactions.

18. (canceled)

19. A computer monitoring system for monitoring transactions involving a conserved resource, said computer system being configured to:
receive a plurality of data feeds relating to the transactions to be monitored, each data feed comprising successive rows of data, each data row in a given data feed comprising multiple data elements in accordance with a predetermined pattern;
perform grouping analysis on the received data feeds, wherein said grouping analysis determines at least one data element in a first data feed from said plurality of data feeds corresponding to provision of said conserved resource, and at least one data element in a second data feed from said plurality of data feeds corresponding to consumption of said conserved resource; and
reconcile the at least one data element corresponding to provision of said conserved resource against the at least one data element corresponding to consumption of said conserved resource in order to monitor said transactions.
